(19) United States
(12) Patent Application Publication
(10) Pub. No.: US 2016/0076914 A1
(43) Pub. Date: Mar. 17, 2016

(54) Absolute Position Measuring System And Method

(71) Applicant: Baumuller Nurnberg GmbH, Nurnberg (DE)

(72) Inventor: Fritz Rainer Gotz, Kirchheim unter Teck (DE)

(21) Appl. No.: 14/843,438

(22) Filed: Sep. 2, 2015

(30) Foreign Application Priority Data
Sep. 11, 2014 (EP) 14184400

(51) Int. Cl. G01D 5/245

(52) U.S. Cl. CPC G01D 5/2454

(57) ABSTRACT

In a method for determining the absolute position (φ) of a carrier (4) for scale marks (6) of an incremental encoder (2) with respect to a sensor array (12), having segment lengths (L0, L1, L2, . . . ) differing by pairs between the scale marks (6), measuring signals (x,y) are generated with the sensor array (12), a theoretical phase shift (Δαt) of ideal measuring signals (xi, yi) is determined for each scale segment (10), model signals (xm,ym) are generated on the basis of parameters (P1, P2, . . . ), which model the measuring signals (x,y), the model signals (xm,ym) are adapted to the measuring signals (x,y), the instantaneous model phase shift (Δαm) between the model signals (xm,ym) is determined, the suitable theoretical phase shift (Δαt) with the associated instantaneous scale segment (10) is selected, the absolute position (φ) is determined from the position of the instantaneous scale segment and a relative position (φᵣₑₗ) is determined from the instantaneous phase position (αm) of the model signals (xm, ym) within the instantaneous scale segment.

### BACKGROUND OF THE INVENTION

The invention relates to an incremental encoder, which may, for example, be a linear, or else, in particular, also a rotary measuring system, i.e., a rotary encoder. In known incremental encoders, i.e., cyclically absolute positioning encoders, mark divisions (distance from mark to mark) are scanned, which—in the case of a rotary encoder—may be formed on a rotary, rotationally symmetrical or—in the case of a linear measuring system—linear, longitudinally movable scale carrier. The scaling may, as is known per se, be implemented by consecutively alternating magnetic and non-magnetic, optically transparent and non-transparent segments, or by teeth and tooth gaps (on a gear or a gear rack). The encoder includes scanning elements that respond to the scale marks. A corresponding output signal is received at the output of the corresponding scanning element, for example, a sequence of current pulses or voltage pulses, the number (increments) of which correspond to an approximate angle position value or longitudinal position value.

A method is known from DE 43 31 151 C2 for determining the absolute position of the movable scale marks carrier within a scale segment formed and/or delimited by two adjacent scale marks on the carrier. It is possible in a microcomputer to combine the number of counted scale marks or scale segments (rough position) and the ascertained absolute position (precise position) relative to the overall position according to known mathematical relationships. A mathematical model of the measuring process is used in DE 43 31 151 C2. The model is based on a parameter vector and is calculated in parallel to the ongoing measuring operation and is constantly updated. In this way, the parameter vector is adapted to the instantaneous measuring process. The contents of DE 43 31 151 C2 are part of the present patent application and form part of the disclosure thereof.

From DE 10 2004 062 278 A1, it is known to fit an incremental encoder with increments (scale segments) the period length (length) of which assumes different values, i.e., they differ by pairs. With the aid of a measurement signal evaluation, it is possible to first determine the instantaneous scale interval (scale segment, rough position) and, by means of a subsequent refined evaluation, to determine through interpolation the absolute position within the instantaneous interval (within the scale segment, precise position).

The object of the invention is to provide an improved absolute position measuring system and method.

### SUMMARY OF THE INVENTION

The object is achieved by a method according to Claim 1. This method is used to determine the absolute position (rough position and precise position, i.e., absolute measuring instead of merely incremental measuring) of a moving carrier for scale marks of an incremental encoder with respect to a sensor array. The sensor array could optionally be stationary. Scale segments having segment lengths differing by pairs are present between the scale marks on the carrier. In a step a), a first measuring signal is generated with a first sensor of the sensor array. Similarly, in a step b), a second measuring signal is generated with a second sensor of the sensor array. The second sensor is disposed offset relative to the first sensor along the direction of movement of the carrier. In other words, therefore, first and second sensors are situated at a respective first and second stationary measuring position with respect to the movable carrier for scale marks. The measuring signals arise as a result of the passing and detection of the scale marks at the sensors. Thus, the second sensor is situated along the direction of movement of the carrier at a second measuring position offset relative to the first measuring position.

In a step c), an ideal operation of the sensors and of the carrier is initially assumed: based on a theoretically ideal case with ideal measuring signals of the first and second sensors, the respective theoretical phase shift between the theoretical ideal measuring signals is determined for each scale segment. Because the segment lengths differ by pairs, the respective theoretical phase shifts of the scale segments also differ by pairs. Thus, each theoretical phase shift and each scale segment may be bijectively associated with one another. The phase shift between the corresponding first and second measuring signals characteristic for and distinctive of a certain scale segment results from the given offset of the sensors of the sensor array, as well as the distinctive characteristic segment length of the particular scale segment.

In a step d), a first and second model signal are generated, which are based on a set of parameters or are defined by the latter. In this case, each of these model signals models the (real) measuring signal related to or associated with it. For this purpose, starting values for the parameters are first used. Subsequently, multiple sub-steps of the method are repeatedly carried out in a step e): in sub-step aa) the respective model signal is adapted to the associated (real) measuring signal by adapting the parameter which defines the model signal. This is achieved based on an adaptation criterion and the instantaneous real values of the measuring signals. The adaptation criterion includes all known adaptation criteria, for example, the smallest error square, gradient methods, etc. Subsequently, in a sub-step bb) the instantaneous model phase shift in the model, i.e., between the model signals, is determined. Of the aforementioned determined theoretical phase shifts, the one which corresponds (best) to the instantaneous model phase shift is then selected in a sub-step cc). The scale segment bijectively associated with the selected theoretical phase shift is selected as the instantaneous scale segment for the (instantaneous) absolute position of the carrier. Thus, the rough position of the carrier is set to the selected scale segment. Finally, in a sub-step dd) the absolute position (φ) of the carrier with respect to the sensor array is also determined from the known position of the instantaneous scale segment (rough position) and the relative position (φᵣₑₗ) within the instantaneous scale segment (precise position). The latter, in turn, is determined from the instantaneous phase position (αm) of the model signals (xm, ym) within the instantaneous scale segment.

With the invention, the absolute position of the carrier is determined directly from the measuring signals. No counting or following of scale marks or scale segments is necessary. The method is interference-free, since in this method the determination of the absolute position within a scale segment is model-based. The determination of the scale segments is also interference-free, since this, too, is model based. The result is an encoder for measuring a high-resolution encoder position. The information on the rough encoder position is therefore expressed by the instantaneous phase shift of both measuring signals. The measuring method is suitable for absolute instead of merely incremental measuring and, and nevertheless cost-effective, applications.

In one preferred embodiment, the instantaneous model phase shift is determined in step bb) from the set of parameters. Since the parameter vector in a corresponding method is generally explicitly present regardless, for example, as a value vector in the memory of a computer, the former is easily accessible for evaluation, which facilitates the determination of the model phase shift.

In a further preferred embodiment of the invention, a (real) complex measuring locus is generated from the (real) measuring signals, in which locus, the first measuring signal is used as its real part and the second measuring signal as its imaginary part. In addition, a complex model locus is generated, the real part of which is formed by the first model signal and the imaginary part of which is formed by the second model signal. In step aa), the model locus is then adapted to the measuring locus in the complex plane. This results in a simultaneous adaptation of the respective model signals to the associated measuring signals. The absolute position of the sensor array is then determined in step dd) from the instantaneous phase position of the model locus. The adaptation of the loci to one another is accompanied by an adaptation of the respective real parts or imaginary parts of the model signals occurring synchronously or independently of one another, which is generally easier and more effectively carried out than a respective single adaptation of the first and second model signal to the first and second measuring signal.

In one preferred embodiment of the invention, the first model signal is represented in step d) in the form

xm=x0+(xc+xd)cos ∝−(yc−yd)sin ∝

and the second signal is represented in the form

ym=y0+(yc+yd)cos ∝+(xc−xd)sin ∝

with the parameter set {x0, y0, xc, yc, xd, yd}. The selection of the aforementioned model with corresponding parameters results in a mathematically particularly simple parameter determination or parameter adaptation. The choice of starting values in step d) offers, for example, the choice of the parameter xc to 1 and the choice of all remaining five parameters to 0. This results in the cosinusoidal shape for the first model signal and the sinusoidal shape for the second model signal as the output signal form to be adapted. By positioning the first and second sensors, adapted with respect to the expected measuring signals, relative to the carrier, it is possible in this way to particularly favorable and rapidly adapt the model signals to the measuring signals. For a comprehensive description of such model signals, we refer to DE 43 31 151 C2, see for example, the equations (16) and (17) or the “comparison model” in FIG. 2 thereof with the relevant description. The robustness of the method presented therein in terms of local or temporal faulty measurements (“anomalies”) is also applicable to the present method.

In one preferred embodiment of the invention purely cosinusoidal measuring signals are assumed in step c) to be theoretically ideal measuring signals, which have as period lengths the segment lengths of the respective scale segments, and in each case have the same phase angle at the start thereof (when the adjacent scale mark passes the particular sensor). Crucial in this case is the profile of the theoretically ideal measuring signals as “cosinusoidal”. Thus, in the case of a corresponding phase angle at the start of the scale segment it may, strictly speaking, also be a sinusoidal shape, for example.

In a further embodiment of the method, the first model signal is represented in step bb) in the form

xm=x0+a cos ωt+b sin ωt=x0+c sin(ωt+γ)

and the second model signal in the form

ym=y0+d cos ωt+e sin ωt=y0+f sin(ωt+η)

The phase shift is then determined from the difference γ−η as follows (see in this regard “Hütte. Des Ingenieurs Taschenbuch. Theoretische Grundlagen. [Engineer's Pocketbook. Theoretical Fundamentals. 28th newly revised ed., Berlin, Verlag von Wilhelm Ernst & Sohn, (1955), p. 568”):

$$x - x 0 = ( x c + x d ) cos ∝ - ( yc - y d ) sin ∝ \\ y - y 0 = ( y c + y d ) cos ∝ + ( xc - xd ) sin ∝ \\ a cos ω t + b sin ω t = c sin ( ω t + γ )$$

$${c}^{2} = {a}^{2} + {b}^{2} , \\ tan γ = \frac{a}{b}$$

in which

$$a = {x}_{c} + {x}_{d} , \\ b = - {y}_{c} + {y}_{d}$$

$${c}^{2} = {( {x}_{c} + {x}_{d} )}^{2} + {( - {y}_{c} + {y}_{d} )}^{2} , \\ tan γ = \frac{{x}_{c} + {x}_{d}}{- {y}_{c} + {y}_{d}}$$

and

$$d cos ω t + e sin ω t = f sin ( ω t + η )$$

$${f}^{2} = {d}^{2} + {e}^{2} , \\ tan η = \frac{d}{e}$$

in which

$$d = {y}_{c} + {y}_{d} , \\ e = {x}_{c} - {x}_{d}$$

$${f}^{2} = {( {y}_{c} + {y}_{d} )}^{2} + {( {x}_{c} - {x}_{d} )}^{2} , \\ tan η = \frac{{y}_{c} + {y}_{d}}{{x}_{c} - {x}_{d}}$$

The phase shift between x−x0 and y−y0 is the difference between γ and η. Such a signal representation is mathematically particularly simple to manipulate and results in a particularly simple determination of the model phase shift. In particular in connection with the aforementioned mathematical representation of the model signals in step d).

In a further preferred embodiment of the invention, the second sensor is disposed offset in step b) relative to the first sensor by at most half the smallest segment length along the carrier. This limitation serves to ensure the determination of respective distinct theoretical phase shifts between theoretically ideal measuring signals in step c), and thereby the bijective assignability to the respective scale segments.

The object of the invention is further achieved by a carrier for scale marks of an incremental encoder according to Claim 8. Scale segments are disposed on the carrier along a direction of movement. The segment length between the scale marks is different for each of the pair of scale segments. A first scale segment is disposed approximately centrally on the carrier in the direction of movement of the carrier. For a circular carrier of a rotary encoder, “central” in the circumferential direction refers to a reference angle, i.e., to an “end point” of the carrier. The first scale segment has a base length. The lengths of the remaining scale segments along the direction of movement, starting from the first scale segment, solely increase, in each case alternately. In one alternative embodiment of the invention, the lengths of the remaining scale segments solely decrease on both sides, in each case alternately, starting from the first scale segment.

The result of this carrier design is that, despite scale segments of different sizes, two adjacent scale segments each differ only minimally in terms of their segment length; this applies to linear or rotary carriers. This, in turn, when employing the aforementioned method, for example, results in merely small changes in the respective theoretical phase shift of measuring signals in adjacent scale segments. In the case of a rotary carrier for scale marks, the design according to the invention also means that the scale segments furthest removed from the first scale segment (which adjoin one another at the aforementioned “end point”) likewise differ minimally in terms of their segment length. This creates in this case an annular closed arrangement, in which all adjacent scale segments on the entire ring formed by the carrier each differ only minimally in their segment length. The small difference between the segment lengths of the scale segments means, in particular, that in the aforementioned method, the model need only be minimally adapted when a segment boundary is exceeded since, for example, the phase shifts in adjacent scale segments differ only minimally. In other words, the model is able to easily follow the real conditions. The incremental coder is suitable, owing to the carrier, as an absolute position measuring system, for example, in connection with the aforementioned method.

In one preferred embodiment of the invention, the first scale segment is joined on both sides along the direction of movement in each case by an equal number of additional scale segments. The result in the case of a rotary carrier, in particular with the constant increase in the segment lengths between individual segments on both sides, is that the “edge” scale segments, which adjoin one another at the end point, differ only minimally in size.

In one preferred embodiment, each of the scale segments has a length that corresponds to a base length L0 plus a whole-numbered multiple (factor) n of a length increment ΔL. The value of the whole-numbered multiple n in this case may include zero. For the case in which the segment length solely increases, the factors n are equal to zero or are positive. When segment length is solely reduced, the multiples are equal to zero or are negative. In particular, complete whole-numbered multiples are used in order to obtain minimal jumps in scale segment length between individual scale segments, i.e., the factors n of all scale segments each differ only by the value of one.

In one preferred embodiment, the middle first—as the smallest or largest—scale segment has the base length. Based on this, the remaining scale segments are each larger or smaller by complete whole-numbered multiples of the length increment, the multiples,—starting from the first scale segment—being even numbered in the one direction (in or against the direction of movement) and odd-numbered in the opposite direction. This embodiment constitutes the one having the minimum possible differences in length between all adjacent scale segments.

In one preferred embodiment, the lengths of the two edge scale segments differ only by the length increment. This is a necessary consequence, for example, of the aforementioned design having an equal number of uniformly increasing scale segments on each side of the first scale segment.

In one preferred embodiment, the length increment ΔL has a size in the range of 0.1% to 10% of the base length L0. Length increments from this range of values result in practicable embodiments of the invention.

As mentioned several times above, the carrier in a preferred embodiment is a self-contained, annular, in particular, circular carrier of a rotary encoder. The division of the scale segments—i.e., the sizes of all the scale segments—is then selected in such a way that all scale segments along the direction of movement adjoin one another completely and without overlapping. In particular, the two largest or smallest edge segments abut one another at the aforementioned end point completely and without overlapping.

The object is also achieved by the use according to Claim 15 of a carrier according to one of Claims 8 through 14 in a method according to one of Claims 1 through 7. Such a use of a carrier combines the advantages of both the aforementioned carrier as well as the aforementioned method and results in synergetic effects, as already mentioned above, since the model signal used is able, for example, to easily follow the changing phase shifts.

### BRIEF DESCRIPTION OF THE DRAWINGS

For a further description of the invention, we refer to the exemplary embodiments of the drawings, in which, in each case in a schematic sketch:

FIG. 1 shows a carrier of a rotary encoder,

FIG. 2 shows ideal and real measuring signals of the rotary encoder from FIG. 1,

FIG. 3 shows the generation of model signals to the measuring signals from FIG. 1,

FIG. 4 shows complex loci of the measuring signals and model signals from FIG. 3.

### DETAILED DESCRIPTION

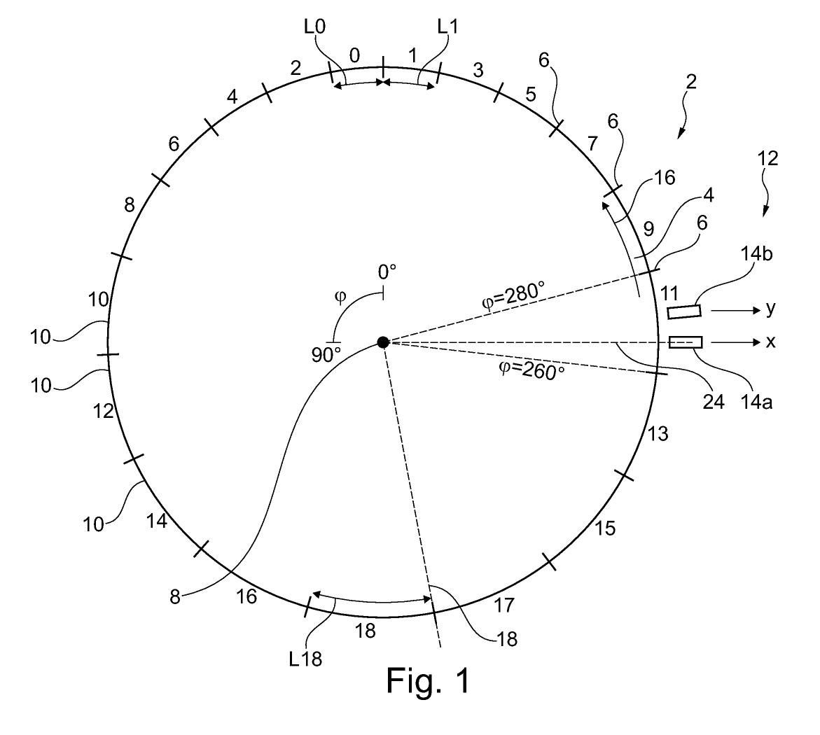

FIG. 1 shows an incremental encoder 2 in the form of a rotary encoder having a circular carrier 4 for scale marks 6. The carrier 4 is mounted for rotational movement about a rotational axis 8. The scale marks 6 delimit respective scale segments 10, which are numbered through in FIG. 1 with segment numbers “0” through “18” and are also referred to in the following as “segment” for short. The first segment “0” is followed clockwise by all odd segment numbers (1, 3, . . . , 17) and counterclockwise by all even segment numbers (2, 4, . . . , 18).

The incremental encoder 2 also includes a sensor array 12 having a first sensor 14a and a second sensor 14b, which could be installed resting stationary, for example. The carrier 4, when moved, rotates about the rotational axis 8, for which reason the scale marks 10 and scale marks 6 are guided past the sensors 14a, b, for example, in a direction of movement 16 of the carrier 4.

All of the scale segments 10 have distinct and varying segment lengths L0 through L18, i.e., differing by pairs. Disposed relative to an “end point” 18 approximately in the center of the carrier (intended radial, which assigns the carrier 4 an “end”) along the direction of movement 16 (thus, in the circumferential direction) is the first scale segment 10 with the segment number “0”. At the same time, the segment length L0 thereof represents a base length for all scale segments 10. The segment lengths L1 through L18 of the remaining segments having numbers “1” to “18” are without exception larger and increase respectively in their segment length, starting from the first scale segment on both sides along the carrier, thus, here in the circumferential direction. The increase in this case occurs alternately on both sides of the first segment. This means, therefore, L18>L17>L16> . . . >L2>L1>L0. In addition, an equal number, namely in each case nine, of additional scale segments (2-18 and 1-17) are situated on both sides of the first scale segment between the first scale segment “0” and the end point 18.

The lengths of the scale segments are formed in such away that the segment number can be equated with the value of the factor n (whole-numbered multiple), wherein Ln=L0+nΔL with n=0, 1, . . . , 18, L0 being the base length and ΔL being the length increment. In an alternative embodiment not depicted, the first scale segment having the base length L0 is the largest scale segment, and the respective lengths of the adjoining scale segments decrease in accordance with aforementioned formation rule. The factor n then assumes the values n=0, −1, . . . , −18. One consequence of the aforementioned formation rule, namely, segment lengths having completely whole-numbered multiples of the length increment ΔL and the base length L0 and an equal number of scale segments on both sides of the first scale segment, is that the two edge scale segments, thus, the segments “17” and “18” adjacent the end point 18, differ only by the length increment ΔL.

In FIG. 1 the number of scale segments, the base length L0 and the length increment ΔL are selected so that with a given circumference of the carrier 4, all scale segments 10 abut one another completely and without overlapping, i.e., are specifically placed on the corresponding circumference of the carrier 4.

In an alternative embodiment not depicted, the incremental encoder 2 is designed as a linear encoder. The scale segments 10 in this case are straight and ordered in series along a straight line corresponding to the straight delineated circumferential line of the carrier 4 shown when said line is separated at the end point 18. The direction of movement 16 in such case is likewise a straight line. The first scale segment with the number “0” is then followed in the one direction to the first end of the carrier by the segments “2” through “18”. The segments “1” through “17” follow in the opposition direction to the other end of the carrier.

When the incremental encoder moves about the rotational axis 8, the absolute position thereof φ (position of the scale marks 6 between “0” and “1”) is to be determined in the form of a rotational angle, in this case, starting from the zero position 24 shown by dashed lines in FIG. 1. For this purpose, the first and second measuring signals x, y generated by the sensors 14a, b are used. The measuring signals x, y occur as a result of the fact that the scale markings 6 are moved in the direction of movement 16 past the first and second sensors 14a, b, which respond to the scale marks 6. The absolute position of the carrier 4 is determined by the following method:

First, the measuring signal x is generated with the aid of the first sensor 14a and the measuring signal y is generated with the aid of the second sensor 14b. In the example, the carrier 4 from FIG. 1 moves in the counterclockwise direction. Since the same scale marks 6 pass the first sensor 14a before the second sensor 14b, the measuring signal x moves in advance of the measuring signal y. The (real, impacted by measuring errors, etc.) measuring signals x, y are depicted in FIG. 2 for passing the segments “11” and “13” in FIG. 2. In addition to the actual measuring signals x, y, theoretical ideal measuring signals xi, yi are also generated, which ideal first and second sensors 14a, b would generate with ideal scale marks 6 under ideal conditions. These are assumed to be purely cosinusoidal. The cosine signals in this case have the period lengths of the respective segment lengths L11 and L13, the latter exhibiting identical phase positions (in this case, phase 0) at the beginning of the respective segments.

Based on the ideal measuring signals xi, yi, the respective theoretical phase shift Δαt within the particular scale segment is determined. In segment “11” the result is Δαt=90°, in segment “13” the result is Δαt=60°. The numerical values used in the example are for illustrative purposes only and do not necessarily correspond to real conditions.

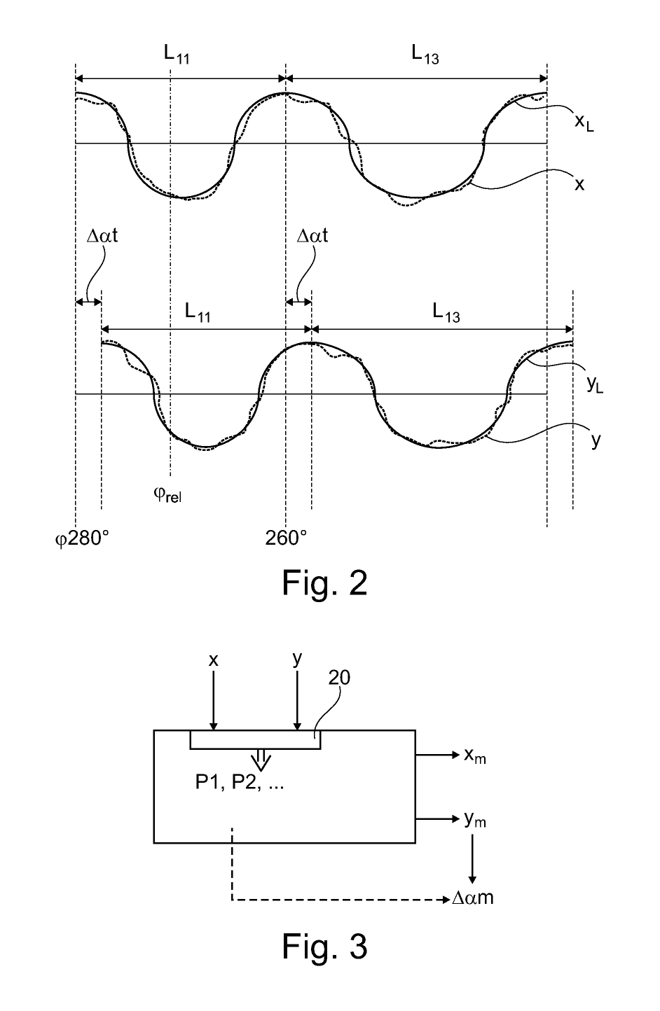

In FIG. 3, model signals xm and ym are then generated, which model the first and second measuring signals x, y. The model signals xm and ym are based on a parameter set P1, P2 . . . , which unambiguously defines the signals. Starting values for the parameters P1, P2, . . . are used as a starting point. The model signals xm and ym are continuously modified and adapted by means of the real measuring signals x, y and an adaptation criterion 20 during the on-going measuring operation, so that these reflect as precisely as possible the measuring signals x,y. Between the model signals xm and ym the resultant instantaneous model phase shift Δαm is then determined, in the example, at 88°. The phase shift that most closely corresponds to the instantaneous model phase shift Δαm is then selected from the previously determined various theoretical phase shifts Δαt (in this case, 90° and 60°). In the present case, this is the theoretical phase shift Δαt=90° of the scale segment “11”. Thus, as a rough position it is known that the instantaneous value of the absolute position φ lies in the range of segment “11”, is i.e., approximately between φ=260° and φ=280° according to FIG. 1. Finally, the instantaneous phase position αm is determined from the model signals xm and ym, which indicates the position φᵣₑₗ of the sensor array 12 within the scale segment “11”. A value of αm=0° (φᵣₑₗ=0°) would then result in a value φ=260° (start of segment “11”), a value of αm=360° (φᵣₑₗ=30°) would result in a value of φ=280° (end of segment “11”). The instantaneous result is αm=120° and, therefore, φᵣₑₗ=10° as the precise position and, therefore, φ=270° as the instantaneous phase position.

FIG. 3 shows with dashed lines the aforementioned alternative method (as calculated by “Hütte”) for determining the model phase shift Δαm from the set of parameters P1, P2, . . . To determine the phase position αm from the measuring signals x and y and the model signals xm and ym, we refer to DE 43 31 151 C2 FIG. 2 in conjunction with the relevant description. The method presented therein may be expanded according to the variant shown by dashed lines in FIG. 3, i.e., the instantaneous model phase shift Δαm is then determined from the parameter set at the end of the integrating or summation step 21.

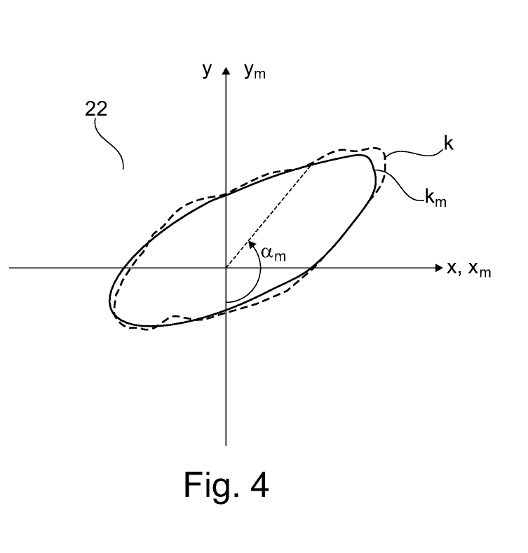

FIG. 4 shows how a complex measuring locus K in the complex plane 22 is generated from the first measuring signal x and the second measuring signal y by using them as a real part and an imaginary part. Likewise, a complex model locus Km is generated from the first model signal xm as the real part and the second model signal ym as the imaginary part. The respective model signal xm, ym is adapted to the associated measuring signal x, y by adapting the model locus Km to the measuring locus K in the complex plane 22. The instantaneous phase position αm is determined at the model locus Km as described above (DE 43 31 151 C2).

### LIST OF REFERENCE NUMERALS

2 Incremental encoder
4 Carrier
6 Scale mark
8 Rotational axis
10 Scale segment
12 Sensor array
14a,b First, second sensor
16 Direction of movement
18 End point
20 Adaptation criterion
22 Complex plane
24 Zero position
L0, L1, . . . Segment length
L0 Base length
ΔL Length increment
x, y First, second measuring signal
xi, yi First, second ideal measuring signal
xm, ym First, second model signal
φ Absolute position
φᵣₑₗ Relative position
Δαt Theoretical phase shift
Δαm Instantaneous model phase shift
αm Instantaneous phase position
P1, P2, . . . Parameters
K Locus
Km Model locus
n Whole-numbered multiple

1. A method for determining the absolute position (φ) of a moving carrier (4) for scale marks (6) of an incremental encoder (2) with respect to a sensor array (12), wherein scale segments (10) having segment lengths (L0, L1, L2, . . . ) differing by pairs are present between the scale marks (6) on the carrier (4), comprising the following steps:
a) generating a first measuring signal (x) with a first sensor (14a) of the sensory array (12),
b) correspondingly generating a second measuring signal (y) with a second sensor (14b) of the sensor array (12), which is disposed offset relative to the first sensor (14a) along a direction of movement (16) of the carrier (4),
characterized by the further steps:
c) for each scale segment (10): theoretically determining a respective is theoretical phase shift (Δαt) between theoretically ideal measuring signals (xi, yi) of the first (14a) and second sensors (14b),
d) generating a first (xm) and second model signal (ym) based on a set of parameters (P1, P2, . . . ), and which model the first (x) and second associated measuring signal (y) respectively, using starting values for the parameters (P1, P2, . . . ),
e) repeatedly carrying out the steps:
aa) adapting the respective model signal (xm,ym) to the associated measuring signal (x,y) by adapting the parameters (P1, P2, . . . ) based on an adaptation criterion (20) and instantaneous values of the measuring signals (x,y)
bb) determining an instantaneous model phase shift (Δαm) between the model signals (xm,ym),
cc) selecting the theoretical phase shift (Δαt) corresponding to the instantaneous model phase shift (Δαm) and choosing as an instantaneous scale segment (10) for the absolute position (φ) the scale segment (10) related to the selected theoretical phase shift (Δαt),
dd) determining the absolute position (φ) of the carrier (4) with respect to the sensor array from the known position of the instantaneous scale segment and from a relative position (φᵣₑₗ) within the instantaneous scale segment, which is defined based on an instantaneous phase position (αm) of the model signals (xm, ym) within the instantaneous scale segment.

2. The method according to claim 1, in which in step bb), the instantaneous model phase shift (Δαm) is determined from the set of parameters (P1, P2, . . . ).

3. The method according to claim 2, in which,
a complex measuring locus (K) is generated from the first measuring signal as the real part (x) and from the second measuring signal (y) as the imaginary part,
a complex model locus (Km) is generated with the first model signal (xm) as the real part and the second model signal (ym) as the imaginary part,
the respective model signal (xm,ym) is adapted to the associated measuring signal (x,y) in step aa) by adapting the model locus (Km) to the measuring locus (K),
the absolute position (φ) is determined in step dd) from the instantaneous phase position (αm) of the model locus.

4. The method according to claim 3, in which in step d) the first model signal (xm) is represented in the form
xm=x0+(xc+xd)cos ∝−(yc−yd)sin ∝
and the second model signal (ym) is represented in the form
ym=y0+(yc+yd)cos ∝+(xc−xd)sin ∝
wherein the parameters {x0,y0,xc,yc,xd,yd} form the parameter set (P1, P2, . . . ).

5. The method according to claim 4, in which in step c) purely cosinusoidal measuring signals (xi,yi) are assumed to be theoretical ideal measuring signals (xi, yi), which cosinusoidal measuring signals have as their period length, the segment length (L0, L1, . . . ) of the respective scale segment (10), and each of which have the same phase angle at the start of the same scale segment (10).

6. The method according to claim 5, in which in step bb),
the first model signal (xm) is represented in the form
xm=x0+a cos ωt+b sin ωt=x0+c sin(ωt+γ)
and the second model signal (ym) is represented in the form
ym=y0+d cos ωt+e sin ωt=y0+f sin(ωt+η)
and the instantaneous model phase shift (Δαm) is determined from the difference γ−η.

7. The method according to claim 6, in which in step b), the second sensor (14b) is disposed offset along the carrier (4) relative to the first sensor (14a) by at most half the smallest segment length (L0, L1, L2, . . . ).

8. A carrier (4) for scale marks (6) of an incremental encoder (2), wherein scale segments (10) having segment lengths (L0, L1, L2, . . . ) differing by pairs are disposed between the scale marks (6) on the carrier (4) along a direction of movement (16),
characterized by
a first scale segment (10) of a base length (L0) disposed approximately centrally in the direction of movement (16),
wherein the segment lengths (L0, L1, L2, . . . ) of the remaining scale segments (10) each alternately solely increase or solely decrease along the direction of movement (16) on both sides starting from the first scale segment (10).

9. The carrier (4) according to claim 8, in which the first scale segment (10) is followed on both sides along the direction of movement (16) in each case by an equal number of additional scale segments (10).

10. The carrier (4) according to claim 9, in which each of the scale segments (10) has a segment length (L0, L1, L2, . . . ), which corresponds to the base length (L0) plus a whole-numbered multiple (n) of a length increment (ΔL).

11. The carrier (4) according to claim 10, in which the smallest or largest scale segment (10) has the base length (L0) and, based on this, the remaining scale segments (10) are each larger or smaller by complete whole-numbered multiples (n) of the length increment (ΔL), wherein the multiples (n) are even numbered in or counter to the direction of movement (16) and odd-numbered in the opposite direction.

12. The carrier (4) according to claim 11, in which the segment lengths (L0, L1, L2, . . . ) of the two edge scale segments (10) differ only by the length increment (ΔL).

13. The carrier (4) according to claim 12, in which the size of the length increment (ΔL) is in the range of 0.1% to 10% of the base length (L0).

14. The carrier (4) according to claim 13, which is a self-contained annular, in particular, circular carrier (4) of an incremental encoder (2) in the form of a rotary encoder, and in which a division of the scale segments (10) is selected in such a way that all scale segments (10) adjoin one another completely and without overlapping along the direction of movement (16).

15. (canceled)
